(19) United States
(12) Patent Application Publication
(10) Pub. No.: US 2010/0270161 A1
(43) Pub. Date: Oct. 28, 2010

(54) APPARATUS FOR PHYSICALLY SEPARATING POLAR SUBSTANCE

(76) Inventor: Uk Hyun, Seoul (KR)

Correspondence Address: BERLINER & ASSOCIATES, 555 WEST FIFTH STREET, 31ST FLOOR, LOS ANGELES, CA, 90013, US

(21) Appl. No.: 12/521,171

(22) PCT Filed: Dec. 24, 2007
(86) PCT No.: PCT/KR2007/006791

§ 371 Date: Jun. 25, 2009

(30) Foreign Application Priority Data
Dec. 27, 2006 (KR) 10-2006-013498

(51) Int. Cl. C02F 1/58

(52) U.S. Cl. 204/665

(57) ABSTRACT

Disclosed is an apparatus for separating a polar ionic substance, such as nitrate nitrogen (NO), from groundwater or a water supply and concentrating the separated substance. The apparatus includes a case having an inlet formed so that the fluid can flow into the case, a diluted fluid outlet formed so that the fluid can be discharged after the fluid has been diluted by separating the polar substance from the fluid, and a concentrated fluid outlet formed so that the fluid can be discharged, the separated polar substance having been concentrated in the fluid; an anode and a cathode installed inside the case while being spaced from each other and supplied with external power; and at least one spacer having pores formed so that the fluid and the polar substance can pass through, the spacer being positioned between the anode and the cathode to divide a space between the anode and the cathode into a diluting chamber and a concentrating chamber, the diluting chamber communicating with the inlet and the diluted fluid outlet, the concentrating chamber communicating with the concentrated fluid outlet. The polar substance contained in the fluid inside the diluting chamber is moved to the concentrating chamber through the at least one spacer by a difference in electric potential between the anode and the cathode so that the polar substance is separated and discharged.

### TECHNICAL FIELD

The present invention relates to an apparatus for separating and concentrating a polar substance, and more particularly to an apparatus for separating an ionic substance having a polarity, such as nitrate nitrogen (NO₃⁻), or a specific polar substance contained in various fluids from groundwater or a water supply and concentrating the separated substance.

### BACKGROUND

Recently, the amount of heavy metal contained in groundwater or surface water has gradually increased as a result of intensifying environmental pollution. In rural areas, particularly, the excessive use of nitrates or artificial fertilizers on the soil in the course of farming raises the concentration of nitrate nitrogen in surface water and ground water.

If heavy metal and nitrate nitrogen accumulate in human bodies via drinking water, not only is the immune system impaired, but also serious diseases may occur. Furthermore, the nitrate nitrogen is rapidly absorbed into the body of infants before the age of one, and is reduced to nitrite in the body through the reduction action of microorganisms. The nitrite reacts with hemoglobin in the blood and creates methemoglobin, which is blood pigment having no oxygen-carrying function. The resulting lack of oxygen may cause cyanosis.

Therefore, the WHO limits the concentration of nitrate nitrogen in drinking water up to 50 ppm, and the concentration is limited up to 10 ppm in Korea.

In most water treatment processes, pollutants (e.g. heavy metal) are conventionally removed physically through a membrane separation process with little difficulty. However, nitrate nitrogen ions (NO₃⁻) are difficult to treat physically, and the treatment cost is high. Therefore, various methods for treating nitrate nitrogen have been recently developed, including ion exchange, electrodialysis, reserve osmotic membranes, nanofilters, biological denitrification, and chemical denitrification.

Most of the nitrate nitrogen treatment methods are based on the fact that nitrate nitrogen ions (NO₃⁻) are negatively charged, and selectively separate nitrate nitrogen and move it.

However, the above-mentioned nitrate nitrogen treatment methods have the following problems.

In the case of the ion exchange type, nitrate is adsorbed onto ion exchange resin to be removed. The ion exchange resin must undergo periodic chemical regeneration, which causes secondary environmental pollution.

In the case of the electrodialysis type, direct current is used to move negative charges from the cathode to the anode so that the ion exchange membrane selectively transmits anions only to separate them. The ion exchange membrane selectively transmits ions only while the movement of water is interrupted.

The crucial factor directly connected to the treatment efficiency in the electrodialysis is current density, and the larger the current density is, the smaller surface area the membrane needs to have. However, excessive current density causes undesired results, such as variation of pH, and there is a limit to the increase in current density and, therefore, to the increase in treatment efficiency.

The ion exchange membrane used in electrodialysis is also very expensive, which is economically unfavorable.

In the case of the reverse osmotic membrane type, pressure is applied to polluted water to obtain treated water through the osmotic membrane. High treatment efficiency requires high pressure, and water must be circulated through the interior at least two times. This treatment type has a problem in that the amount of treated water is small compared with that of inputted raw water. In addition, an expensive pre-treatment process is necessary to solve the problem of membrane contamination, etc.

The nanofilter type is advantageous in that not only nitrate nitrogen but also all other types of water pollutants are removed. However, this type requires periodic re-generation as in the case of the reverse osmotic membrane type, and power of at least 6 KWh/m³ must be spent to treat 100 tons per day. As such, the nanofilter type requires a high operating cost.

In the case of the biological denitrification type, harmless gaseous nitrogen (N₂) is used to treat nitrate nitrogen (NO₃⁻) instead of the ion exchange resin. However, the excessive biomass created during the process must be removed together with the carbon source from the treated water. This requires multiple post-treatment steps, including repeated filtering and disinfecting steps.

The chemical denitrification type is based on the tendency for some metal to lose electrons, and reduces anions so that nitrate nitrogen is reduced to ammonia. The chemical denitrification relies on hydrogen or iron/palladium (Pd)-based catalysts. As a result, a large amount of ammonia and sludge are created in comparison to the efficiency, and the cost is high. Furthermore, the safety problem resulting from the concentration of employed metal must also be solved.

In summary, conventional nitrate nitrogen treatment methods require an expensive pre-treatment or post-treatment process to deal with pollutants created during the process, and thus are not cost-efficient.

Such problems are not limited to processes for treating nitrate nitrogen in water, but similarly occur to different treatment processes for removing a specific substance having a polarity from a fluid.

### DISCLOSURE OF INVENTION

### Technical Problem

Therefore, the present invention has been made in view of the above-mentioned problems, and the present invention provides an apparatus for separating a polar substance, which is structured and operated in a simple manner to physically separate a polar substance from a fluid and treat it at a high efficiency, and which has a substantially reduced treatment cost (i.e. better economy).

### Technical Solution

In accordance with an aspect of the present invention, there is provided an apparatus for separating a polar substance from a fluid containing the polar substance, the apparatus including a case having an inlet formed so that the fluid can flow into the case, a diluted fluid outlet formed so that the fluid can be discharged after the fluid has been diluted by separating the polar substance from the fluid, and a concentrated fluid outlet formed so that the fluid can be discharged, the separated polar substance having been concentrated in the fluid; an anode and a cathode installed inside the case while being spaced from each other and supplied with external power; and at least one spacer having pores formed so that the fluid and the polar substance can pass through, the spacer being positioned between the anode and the cathode to divide a space between the anode and the cathode into a diluting chamber and a concentrating chamber, the diluting chamber communicating with the inlet and the diluted fluid outlet, the concentrating chamber communicating with the concentrated fluid outlet, wherein the polar substance contained in the fluid inside the diluting chamber is moved to the concentrating chamber through the at least one spacer by a difference in electric potential between the anode and the cathode so that the polar substance is separated and discharged.

### Advantageous Effects

According to present invention, the to-be-concentrated polar substance is easily accelerated by the filler and moved to the concentrating chamber, which then concentrates the substance and discharges it. Therefore, instead of an expensive ion exchange membrane, etc., a separation membrane equivalent to a microfiltration membrane can be used as a spacer to separate the to-be-concentrated polar substance. The filler, electrode, etc. may also be made of inexpensive materials. This substantially reduces the cost for manufacturing and maintenance, and improves the recovery ratio.

For reference, the term “polar substance” used herein is not limited to its meaning as defined in the dictionary, i.e. a substance having an asymmetric atomic arrangement direction when crystals having no symmetric center travel in one direction as well as in the opposite direction, but also includes substances having an electric or electrostatic polarity, such as ions and colloidal substances.

### BRIEF DESCRIPTION OF THE DRAWINGS

The foregoing and other objects, features, and advantages of the present invention will become more apparent from the following detailed description when taken in conjunction with the accompanying drawings in which:

FIG. 1 is a longitudinal sectional view briefly showing an apparatus for separating a polar substance according to an embodiment of the present invention, which separates nitrate nitrogen ions from water and concentrates them; and

FIG. 2 is a longitudinal sectional view briefly showing an apparatus for separating a polar substance according to anther embodiment of the present invention.

### BEST MODE FOR CARRYING OUT THE INVENTION

Hereinafter, exemplary embodiments of the present invention will be described with reference to the accompanying drawings.

It is to be noted that, although the present invention will be described with regard to an apparatus for selectively separating and removing nitrate nitrogen ions (NO₃⁻) from water as an embodiment of an apparatus for separating a polar substance, the present invention is not limited to the exemplary apparatus, and is equally or similarly applicable to different apparatuses for separating a specific polar substance (e.g. ions, colloidal substances) from a fluid and treating it.

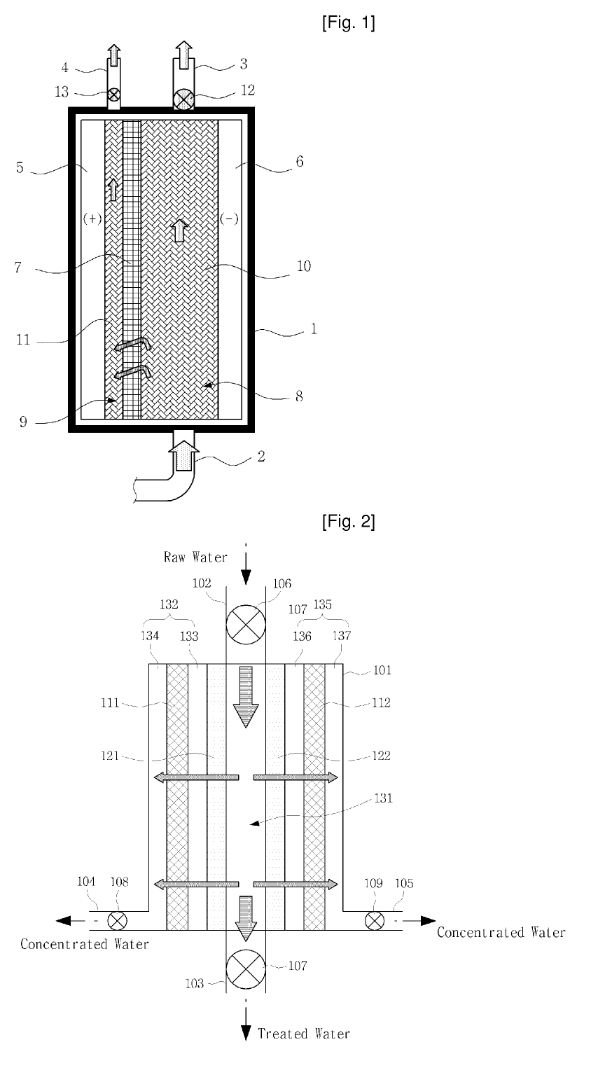

FIG. 1 shows an apparatus for separating nitrate nitrogen ions (NO₃⁻) as an embodiment of an apparatus for separating a polar substance according to the present invention. The apparatus includes a case 1, an inlet 2 formed on the lower end of the case 1 so that a fluid containing nitrate nitrogen ions can flow in, a treated water outlet 3 formed on the upper end of the case 1 so that treated water, from which nitrate nitrogen ions have been separated, and which has been diluted, can be discharged, and a concentrated water outlet 4 formed separate from the treated water outlet 3 so that separated nitrate nitrogen ions can be concentrated and discharged.

An anode (+) 5 and a cathode (−) 6 are positioned inside the case 1 while facing each other. The anode 5 and cathode 6 are preferably supplied with DC power. To this end, the separation apparatus according to the present invention preferably has a rectifier (not shown) for supplying the anode 5 and cathode 6 with DC power.

A spacer 7 is placed between the anode 5 and cathode 6 so that the space between the anode 5 and the cathode 6 is separated and delimited. The spacer 7 may be made of a microfiltration membrane having micropores, through which a fluid and nitrate nitrogen ions can pass. Alternatively, the spacer 7 may be made of non-woven fabric, ultra-fine fibers, or electrospinning nanofibers, which have been thermally bonded and/or compressed. The spacer 7 is preferably made of an electrically conductive material having a polarity opposite to that of the to-be-concentrated ions (i.e. nitrate nitrogen ions in this embodiment). However, the material of the spacer 7 is not limited to that, and the spacer 7 may be made of a material having no polarity or a material having the same polarity as the to-be-concentrated ions.

One of the spaces delimited by the spacer 7, which lies between the spacer 7 and the cathode 6, is referred to as a diluting chamber 8, and another space between the spacer 7 and the anode 5 is referred to as a concentrating chamber 9.

The treated water outlet 3 formed on the case 1 communicates with the diluting chamber 8, and the concentrated water outlet 4 communicates with the concentrating chamber 9. The inlet 2 of the case 1 communicates with the lower portion of the diluting chamber 8.

The diluting and concentrating chambers 8 and 9 are filled with fillers 10 and 11, respectively, which are made of fibrous or particulate materials. The fillers 10 and 11 are preferably made of electrically conductive materials, particularly polymer fibers derived from polar monomers, such as PAN (polyacrylonitrile), PET (polyethylene terephthalate) or nylon. Alternatively, the fillers 10 and 11 may be made of materials having no electrical conductivity, such as PE or PP.

When the fillers 10 and 11 are made of electrically conductive materials, the fillers 10 and 11 preferably have a polarity opposite to that of the to-be-concentrated ions (i.e. nitrate nitrogen ions). In this case, the nitrate nitrogen ions are accumulated and activated by positive charges on the surface of the fillers 10 and 11 so that, when there is a difference in electric potential between the anode 5 and the cathode 6, the movement to the anode 5 is accelerated.

When the fillers 10 and 11 are made of materials having the same polarity as nitrate nitrogen ions, the nitrate nitrogen ions are accumulated between the surfaces of the fillers 10 and 11 so that, when there is a difference in electrical potential between the anode 5 and the cathode 6, the movement to the anode 5 is accelerated.

The treated water outlet 3 and the concentrated water outlet 4 are provided with flow rate control valves 12 and 13 to adjust the discharged flow rate and regulate the pressure differential between the diluting and concentrating chambers 8 and 9, respectively. Although both the treated water outlet 3 and the concentrated water outlet 4 are provided with flow rate control valves 12 and 13 according to the present embodiment, a selected one of the treated water outlet 3 and the concentrated water outlet 4 may be provided with a flow rate control valve. Alternatively, no flow rate control valve may be employed.

The operation of the apparatus for separating nitrate nitrogen ions according to the present invention, which is constructed as mentioned above, will now be described.

When an amount of water containing nitrate nitrogen ions flows into the lower portion of the diluting chamber 8 of the case 1 via the inlet 2, a portion of the water flows into the concentrating chamber 9 via the pores of the spacer 7. As such, water separately flows into the diluting and concentrating chambers 8 and 9 inside the case 1.

When DC power is applied to the anode 5 and the cathode 6, a difference in electrical potential occurs between the anode 5 and the cathode 6, and then moves nitrate nitrogen ions (NO₃⁻), which are anions, to the anode 5.

The diluting chamber 8 is filled with the filler 10, as mentioned above. Therefore, the nitrate nitrogen ions are accumulated on the surface of the filler 10 and, when a difference in electrical potential occurs in the diluting chamber 8, move to the anode 5 with acceleration.

After reaching the anode 5, the nitrate nitrogen ions are concentrated inside the concentrating chamber 9 through the pores of the spacer 7, and are discharged to the outside via the concentrated water outlet 4 together with the water flowing inside the concentrating chamber 9.

The water inside the diluting chamber 8 is discharged to the outside via the treated water outlet 3 with nitrate nitrogen ions removed from it.

The flow rate control valves 12 and 13 of the treated water outlet 3 and the concentrated water outlet 4 adjust the pressure differential between the diluting and concentrating chambers 8 and 9 and regulate the discharged flow rate so that the desired efficiency is obtained. Preferably, the ratio between the flow rates of diluted water and concentrated water discharged through the treated water outlet 3 and the concentrated water outlet 4, respectively, is about 9:1.

As such, according to the present invention, water supplied into the case 1 separately flows into the diluting and concentrating chambers 8 and 9, and nitrate nitrogen ions accumulated on the surface of the filler 10 are accelerated by the difference in electrical potential between both electrodes, i.e. anode 5 and cathode 6, so that the ions are easily moved to the concentrating chamber 9 via the spacer 7 and then discharged.

As mentioned above, the fillers 10 and 11 are preferably made of fibrous materials, such as carbon fibers, inorganic fibers, polar polymer fibers, short staples, long staples, non-woven fabric, or woven fabric. The fillers 10 and 11 may also be made of particulate materials. Alternatively, the fillers may include both fibrous and particulate materials. Experiments have proven that, when the fillers 10 and 11 are made of fibrous materials, the smaller the diameter of fibers constituting the fillers is, the higher the concentrating efficiency becomes.

As the fillers 10 and 11, in addition, fibrous ion exchange resin (PAN series) having excellent electrical conductivity may be used.

The spacer 7 may be made of a membrane having a pore size of a number of micrometers (>0.010), which is equivalent to a microfiltration membrane, as mentioned above. Alternatively, the spacer 7 may be made of an ultrafiltration membrane having a pore size smaller than that of the microfiltration membrane. The thinner the spacer 7 is, the less power is consumed, because lower resistance is created.

The spacer 7 may be made of non-woven fabric, ultra-fine fibers, or electrospinning nanofibers, which have been thermally bonded and/or compressed, as mentioned above. When the electrospinning is employed to fabricate the spacer 7, nanofibers are spun onto a metal mesh made of stainless steel having excellent resistance to corrosion (preferably, STS 316) and are recovered. The metal mesh is compressed against the nanofiber bonded body before the solvent inside the spun nanofibers is completely evaporated. A spacer film is obtained in this manner. The metal mesh of the spacer 7, which is made of the nanofiber film, may act as a support, on which electrospinning fibers may be staked again so that the spacer 7 is integrated with the fillers 10 and 11 of the concentrating chamber 9.

Alternatively, the spacer 7 may be fabricated by spinning nanofibers onto one side of a support made of a metal mesh, compressing the nanofibers to form a film, and forming another nanofiber layer on the other side.

When the spacer 7 is fabricated according to the electrospinning method, the spacer 7 is not necessarily made of a metal mesh. A mesh made of a polar polymer material (e.g. nylon, PAN, or fluororesin fibers) may be used instead.

In order to further improve the electric conductivity of the spacer 7, an electrically conductive substance, such as lithium hydroxide (LiOH), may be added to the material constituting the spacer.

The anode 5 and cathode 6 may be made of DSAs. Alternatively, the anode 5 and cathode 6 may be made of stainless steel having excellent resistance to corrosion (preferably, STS 316) or a titanium material, the surface of which has been oxidized. The anode 5 and cathode 6 are either of a flat plate type or of a mesh type. The cathode 6 may be made of a porous sintered substance so that it can also act as the filler. Advantageously, if the anode 5 and cathode 6 are of a mesh type, air bubbles created inside the case 1 are removed efficiently.

Although it has been assumed in the description of the present embodiment that the anode 5 and cathode 6 are parallel with each other, the anode 5, the cathode 6, and/or the spacer 7 may have a spiral shape, for example.

In addition, although it has been assumed in the description of the apparatus for separating nitrate nitrogen ions according to the present embodiment of the present invention that the inlet 2 is formed on the lower end of the case 1 and that the treated water outlet 3 and the concentrated water outlet 4 are formed on the upper end of the case 1, the positioning of the inlet 2 and the outlets 3 and 4 is not limited to that.

However, the above-mentioned positioning (i.e. the inlet 2 is formed on the lower end of the case 1, and the treated water outlet 3 and the concentrated water outlet 4 are on the upper end of the case 1) is advantageous in that, since water flows from the bottom to the top, a very small amount of water flowing into the case 1 is electrolyzed, and that resulting oxygen and hydrogen gases are entrained by the upward flow of water (i.e. gases are easily removed). In this case, although not shown in the drawings, blowers may be installed above the concentrating and diluting chambers 8 and 9 to easily discharge the gases moving to the upper portion of respective chambers.

Meanwhile, water supplied into the case 1 via the inlet 2 may contain pollutants other than nitrate nitrogen ions. Therefore, a pre-treatment separation membrane device having a microfiltration membrane with a pore size smaller than that of the spacer may be installed at the front end of the inlet 2 to pre-treat water supplied into the case 1 via the inlet 2 and to prevent the spacer 7 from being polluted.

The separation apparatus according to the present invention may be provided with a rectifier (not shown) for supplying the anode 5 and cathode 6 with DC power, as mentioned above. The voltage supplied from the rectifier makes it possible to detect the concentration of ionic pollutants, i.e. nitrate nitrogen ions. To be more specific, it will be assumed that a predetermined capacity of electric energy is supplied at a constant ampere and that the voltage is variable. When the concentration of ions in the in-flowing water (i.e. concentration of the electrolyte) is high, the voltage of DC power supplied from the rectifier decreases. If the concentration drops, a higher voltage is supplied to supply the same amount of power. Based on such electric conductivity characteristics, the ion concentration can be detected from the supplied water.

FIG. 2 shows another embodiment of the apparatus for separating polar substances, including nitrate nitrogen ions. The apparatus according to the second embodiment includes a case 101, first and second spacers 121 and 122 positioned at the center of the case 101 while being spaced from each other to delimit a diluting chamber 131, an anode 111 and a cathode 112 positioned outside of the first and second spacers 121 and 122, respectively, and first and second concentrating chambers 132 and 135 delimited in both regions of the case 101, in which the anode 111 and the cathode 112 are positioned, respectively. In other words, according to the second embodiment, first and second spacers 121 and 122 are positioned between the anode 111 and the cathode 112 so that a diluting chamber 131 is delimited between the first and second spacers 121 and 122, and first and second concentrating chambers 132 and 135 are delimited on both sides of the case 101, respectively, in a symmetric manner.

The diluting chamber 131 communicates with the inlet 102 and the treated water outlet 103 of the case 101.

The first and second concentrating chambers 132 and 135 communicate with first and second concentrated water outlets 104 and 105 formed on both sides of the case 101, respectively. The first concentrating chamber 132 may include a filler chamber 133 positioned between the anode 111 and the first spacer 121, and a first concentrated water discharge chamber 134 formed outside of the anode 111. The second concentrating chamber 135 may similarly include a filler chamber 136 positioned between the cathode 112 and the second spacer 122, and a concentrated water discharge chamber 137 formed outside of the cathode 112. The anode 111 and the cathode 112 are made of a porous metallic body or a mesh-type metallic body, through which water can pass.

The diluting chamber 131 and the filler chambers 133 and 136 of the first and second concentrating chambers 132 and 135 are preferably filled with electrically conductive fillers so as to suppress the channeling of flowing water and increase the area of contact between the electrodes (i.e. anode and cathode) and the first and second spacers 121 and 122 so that the efficiency of movement of ions improves.

The first and second spacers 121 and 122 may be made of the same material as that of the spacer according to the above-mentioned first embodiment. Alternatively, the first and second spacers 121 and 122 may be made of a plate membrane or a hollow fiber membrane.

In the drawing, reference numerals 106, 107, 108, and 109 refer to flow rate control valves installed at the inlet 102, the treated water outlet 103, the first concentrated water outlet 104, and the second concentrated water outlet 105, respectively.

The apparatus for separating a polar substance according to the second embodiment of the present invention, which is constructed as mentioned above, is operated as follows: the two spacers 121 and 122 positioned at the center of the case 101 define the diluting chamber 131 so that, among the substances in the water introduced into the diluting chamber 131 via the inlet 102, negatively charged ionic substances (i.e. nitrate nitrogen ions) are directed into the first concentrating chamber 132 through the first spacer 121 and then concentrated. The concentrated substances are discharged via the first concentrated water outlet 104.

In addition, positively charged ionic substances among the substances of water introduced into the diluting chamber 131 are directed into the second concentrating chamber 135 through the second spacer 122 and then concentrated. The concentrated substances are discharged to the outside via the second concentrated water outlet 105.

As such, most polar substances of water flowing into the diluting chamber 132 are separately directed to both sides, and the water is discharged to the outside via the treated water outlet 103 after the polar substances have been removed.

The flow rate of water treated by the apparatus for separating a polar substance according to the second embodiment of the present invention is lower than that by the apparatus according to the first embodiment when the current density is the same. However, the apparatus according to the second embodiment is advantageous in that the scale formed on the cathode 112 can be easily removed. This results from the symmetric structure of the apparatus. More particularly, the polarities of the anode 111 and the cathode 112 are switched after a period of use so that the scale accumulated on the previous cathode 112 undergoes anode oxidation and electrolysis, and is discharged together with the concentrated water. As such, the scale accumulated on the electrode can be easily removed without a separate cleaning process, and the treated water can be recovered continuously.

In addition, according to the second embodiment, the treated water flowing through the diluting chamber 131 makes no contact with the electrodes so that there is no change in pH resulting from electrolysis.

Meanwhile, although a single separation apparatus has been described with regard to the above-mentioned embodiments, a plurality of separation apparatuses may be connected in parallel as a unit cell to increase the capacity of the separation apparatus.

In addition, although it has been assumed that the above-mentioned apparatuses for removing polar substances are used as water purification systems for separating and removing nitrate nitrogen ions from water, the present invention is not limited to such apparatuses for separating and removing nitrate nitrogen ions from water, but is equally or similarly applicable to apparatuses for separating various specific polar substances or ions from fluids.

As mentioned above, the apparatuses for separating polar substances according to the present invention are advantageous in that, instead of using an expensive ion exchange membrane, a separation membrane equivalent to a microfiltration membrane is used as the spacer. In addition, the fillers, electrodes, etc. may also be made of inexpensive materials. This substantially reduces the cost for manufacturing and maintenance.

The operating pressure of the inventive apparatuses is at the atmospheric level so that, compared with other membrane separation processes (e.g. reverse osmosis), less power is consumed. In addition, polar substances are separated physically without using chemicals. This reduces the operating cost.

The fillers of the apparatuses easily accelerate the to-be-concentrated polar substance and move it to the concentrating chamber, which concentrates and discharges the substance. The ratio of recovery of treated water, from which to-be-concentrated ions have been removed, and which has been diluted, is 70-90%, which is higher than other that of other separation methods.

The spacer of the inventive apparatuses has a throughput per area of 3-5 tons/m³ per day, which is three to five times larger than the throughput per membrane area (1 ton/m³)of other apparatuses for separating polar substances using conventional separation membranes.

The inventive apparatuses have a simple construction and are easily applicable to automated systems. The treatment capacity can be easily increased and decreased. Furthermore, the inventive apparatuses can concentrate and separate polar substances more efficiently than conventional apparatuses so that ultra-compact concentrating/separating systems can be constructed.

### INDUSTRIAL APPLICABILITY

The present invention is applicable to various separation apparatuses for separating specific polar substances, ions, or colloidal substances from a fluid and treating them, such as an apparatus for selectively separating and removing nitrate nitrogen ions (NO₃⁻) from groundwater or a water supply.

Although several exemplary embodiments of the present invention have been described for illustrative purposes, those skilled in the art will appreciate that various modifications, additions and substitutions are possible, without departing from the scope and spirit of the invention as disclosed in the accompanying claims.

1. An apparatus for separating a polar substance from a fluid containing the polar substance, the apparatus comprising: a case having an inlet formed so that the fluid can flow into the case, a diluted fluid outlet formed so that the fluid can be discharged after the fluid has been diluted by separating the polar substance from the fluid, and a concentrated fluid outlet formed so that the fluid can be discharged, the separated polar substance having been concentrated in the fluid; an anode and a cathode installed inside the case while being spaced from each other and supplied with external power; and at least one spacer having pores formed so that the fluid and the polar substance can pass through, the spacer being positioned between the anode and the cathode to divide a space between the anode and the cathode into a diluting chamber and a concentrating chamber, the diluting chamber communicating with the inlet and the diluted fluid outlet, the concentrating chamber communicating with the concentrated fluid outlet, wherein the polar substance contained in the fluid inside the diluting chamber is moved to the concentrating chamber through the at least one spacer by a difference in electric potential between the anode and the cathode so that the polar substance is separated and discharged.

2. The apparatus as claimed in claim 1, wherein the spacer comprises a first spacer and a second spacer positioned at a predetermined distance from each other, the diluting chamber is formed between the first and second spacers, and first and second concentrating chambers are formed outside the first and second spacers, respectively.

3. The apparatus as claimed in claim 1, further comprising a filler having pores so that the fluid can pass through, the filler filling the diluting chamber.

4. The apparatus as claimed in claim 1, further comprising a concentrating chamber filler for filling the concentrating chamber.

5. The apparatus as claimed in claim 1, wherein the spacer is made of an electrically conductive material.

6. The apparatus as claimed in claim 5, wherein the spacer is made of an electrically conductive material having a polarity opposite to a to-be-concentrated polar substance.

7. The apparatus as claimed in claim 1, wherein the spacer is made of one selected from the group consisting of non-woven fabric or ultra-fine fibers thermally bonded or compressed, a microfiltration membrane, an ultrafiltration membrane, and a reverse osmotic membrane, and the spacer has a shape of a plate membrane or a hollow fiber membrane.

8. The apparatus as claimed in claim 1, wherein the spacer is made of elec-trospinning nanofibers obtained by spinning nanofibers on a mesh-type support, recovering the nanofibers, and compressing a metal mesh against a nanofiber bonded body before a solvent inside the spun nanofibers is completely evaporated.

9. The apparatus as claimed in claim 8, wherein the support is made of a metal mesh or a polar polymer mesh.

10. The apparatus as claimed in claim 1, wherein the spacer is obtained by adding an electrically conductive substance, such as lithium hydroxide (LiOH).

11. The apparatus as claimed in claim 4, wherein the concentrating chamber filler and the spacer are formed as an integral unit.

12. The apparatus as claimed in claim 3, wherein the filler is made of a fibrous or particulate material.

13. The apparatus as claimed in claim 3, wherein the filler is made of an electrically conductive material.

14. The apparatus as claimed in claim 13, wherein the filler is made of an electrically conductive material having a polarity opposite to a to-be-concentrated polar substance.

15. The apparatus as claimed in claim 3, wherein the filler is made of one selected from the group consisting of ion exchange fibers, carbon fibers, inorganic fibers, polar polymer fibers, short staples, long staples, non-woven fabric, and woven fabric.

16. The apparatus as claimed in claim 1, wherein the anode or the cathode is made of a DSA.

17. The apparatus as claimed in claim 1, wherein the anode or the cathode is obtained by oxidizing a surface of a metal material or a titanium material.

18. The apparatus as claimed in claim 1, wherein the anode or the cathode has a plate shape.

19. The apparatus as claimed in claim 1, wherein the anode or the cathode is or a mesh type.

20. The apparatus as claimed in claim 1, wherein the inlet is adapted to communicate with the diluting chamber at a lower end of the case, the concentrated fluid outlet is adapted to communicate with an upper portion of the concentrating chamber, and the diluted fluid outlet is adapted to communicate with an upper portion of the diluting chamber.

21. The apparatus as claimed in claim 1, wherein a pre-treatment separation membrane device is installed at a front end of the inlet to remove pollutants contained in the fluid supplied to the inlet.

22. The apparatus as claimed in claim 1, further comprising a rectifier for supplying the anode and the cathode with DC power.

23. The apparatus as claimed in claim 1, wherein a plurality of apparatuses for separating a polar substance are arranged in parallel.

24. The apparatus as claimed in claim 1, further comprising a valve for controlling a flow of the fluid discharged via the treated fluid outlet, the polar substance having been removed from the fluid.

25. The apparatus as claimed in claim 1, further comprising a valve for controlling a flow of the fluid discharged via the concentrated fluid outlet, the polar substance having been concentrated in the fluid.
